(19) United States
(12) Patent Application Publication
(10) Pub. No.: US 2017/0020759 A1
(43) Pub. Date: Jan. 26, 2017

(54) ARTICULATED DEVICE WITH A LIFTING MECHANISM, FOR THE TRANSFER OF BEDRIDDEN PATIENTS OR WITH REDUCED MOBILITY, PROVIDED WITH A LATERAL DISPLACEMENT MECHANISM AND TRANSFER MECHANISM

(71) Applicant: Daniel GONÇALO DE FREITAS, Povoacao - Acores (PT)

(72) Inventor: Daniel GONÇALO DE FREITAS, Povoacao - Acores (PT)

(21) Appl. No.: 14/805,150

(22) Filed: Jul. 21, 2015

(51) Int. Cl. A61G 7/16; A61G 7/10

(52) U.S. Cl. CPC A61G 7/16; A61G 7/10; A61G 7/1034

(57) ABSTRACT

An articulated device for the transfer of bedridden patients or with reduced mobility, including an articulated assembly, composed of the costal, the seat, the leg support, interconnected by hinges and cardans system and fixed to the articulated support, by means of the set of six slides, which allow the articulated assembly to slide outward or inward from the center of the articulated support in the right lateral direction by means of the actuator installed in the inner part of the left side of the articulated support.

### TECHNICAL AREA OF THE INVENTION

The application field of the present invention refers to the hospital sector, palliative care and domestic/private sector where the demand for this kind of specific solution is quite obvious in light of the solutions available in the market.

The present invention concerns an articulated device with a lifting mechanism, FOR THE TRANSFER OF BEDRIDDEN PATIENTS or with reduced mobility (FIG. 1), provided with a lateral displacement mechanism (F and G) and a transfer mechanism (E, L and H), which is supported by a carrying body (C).

### STATE OF THE ART

Transfer of bedridden patients or with reduced mobility, as well as the healthcare services for them, has been a problem which affects directly their quality of life.

Nowadays, there are several types of equipments to carry bedridden patients or with reduced mobility, namely: the conventional crane, the stretcher, the wheelchair (manual and electric) and also the transportation mechanism of bedridden patients or with movement or locomotion difficulties with a lifting device, described in the national U.S. Pat. No. 106,213.

This equipment centralizes several technical and operational functions, opposite to the others available that only execute one function, causing a large inconvenience and discomfort, namely for the bedridden patient.

Although this equipment represents an advance in what concerns the transportation of bedridden patients or with reduced mobility, the truth is that the way in which the transfer of the person from that transportation mechanism to another equipment (stretcher/chair/automobile) always implies the use of human strength to complete the transition of the user to another equipment.

Thus, the technical problem in question concerns the transfer of the person, from one equipment to another, such as a stretcher, a bed, a chair or even an automobile.

The new invention will allow, through the introduction of the transfer mechanism (E, L and H) and lateral displacement mechanism (F and G), that the transfer of the person is performed without said person being displaced, since that, positioning the articulated device by the equipment/surface, where the user is and the before mentioned mechanisms being used, it is possible to execute the transfer of the user without the need of other people. In some situations, depending on the circumstances, the user himself can handle the equipment autonomously and make the transfer from it to another surface, allowing for a greater sense of dignity for those longing for this kind of technical help.

This articulated device for the transfer of bedridden patients or with reduced mobility (FIGS. 1 and 2) innovate the manner how the transfer of bedridden patients or with reduced mobility is done and also, the manner in which one-off or palliative, domestic or public healthcare is provided.

It still allows the capability of placing a person with reduced mobility inside a private vehicle without any effort whatsoever to the parties involved.

The purpose of this invention is to provide to its recipients and to those that cooperate with them, namely healthcare professionals, the maximum comfort in its use, as well as to provide costs minimization to institutions and other entities, since only one person is needed to operate the equipment and the patient.

### DESCRIPTION OF THE INVENTION

The present invention establishes an articulated device with a lifting mechanism, FOR THE TRANSFER OF BEDRIDDEN PATIENTS or with reduced mobility (FIGS. 1 e 2), provided with a lateral displacement mechanism (F and G) and a transfer mechanism (E, L and H), which is supported by a carrying body (C).

For this purpose, the invention is composed of five distinct elements:

1) The lifting mechanism composed of a telescopic actuator (A), which is based in the carrying body (C), according to FIG. 1.

2) The articulated assembly (B), according to FIG. 3, composed of 4 elements, interconnected by a hinge and cardans system (J), namely:
Costal (B1), composed of a stainless steel plate and fixed to the articulated support (B4) by means of slides (F);
Seat (B2), composed of a stainless steel plate and fixed to the articulated support (B4) by means of slides (F);
Leg support (B3), composed of a stainless steel plate and fixed to the articulated support (B4) by means of slides (F);
Articulated support (B4), according to FIG. 4, that in turn sits in the telescopic actuator (A), with actuators (I) that allow the oscillation of the costal (B1) from 0° to 90° and vice versa and the leg support (B3) from 180° to 270° and vice versa.

3) Lateral displacement mechanism (F and G), according to FIG. 2, composed of 2 elements, namely:
Slide system (F) which allows the transfer mechanism to slide from its original position outward and vice versa and;
Actuator (G) which pushes the transfer device outwards and vice versa.

4) Transfer mechanism (E and H), according to FIG. 3, composed of 3 elements, namely:
Set of 3 rolling belts made of canvas (E), which are actuated by two rolls (L) each, and which have the function to pick up or deliver back the device's user and also a Rotor (H) that makes the belts roll.

5) Carrying body composed of 2 elements, according to FIG. 5, namely: the steel structure (C) and the wheels (D) which allow it to move.

### Form of Functionality

The articulated device with lifting mechanism (A) for the transfer of bedridden patients or with reduced mobility, by means of an telescopic actuator (A), fixed to the carrying body (C), allows the rising and lowering of the articulated support (B4), which is fixed to the latter (A) in its upper part, according to FIG. 4.

Thereby, the articulated assembly (B), based in the articulated support (B4), besides having ascending and descending movements, still can, in turn, assume two distinct forms, in accordance with the needs of its user, namely:

### b.1) Chair-Shaped Articulated Assembly (B):

To this end, it is necessary to activate the actuators (I), which in turn, are fixed to the articulated support (B4) and ascend counterclockwise (from 90° to 0°) and vice versa the upper part of the articulated assembly (B), designated as costal (B1), and also descend the lower part of the articulated assembly (B), designated leg support (B3) counterclockwise, (from 270° to 180°) and vice versa. In order to allow these oscillations, the parts B1 and B3 of the articulated assembly (B) are fixed to the seat (B2) of the same set by means of hinges and cardans (J).

### b.2) Stretcher-Shaped Articulated Assembly (B):

To this end, it is necessary the actuators (I), which in turn, are fixed to the articulated support (B4) and descend clockwise (from 0° to 90°) and vice versa the upper part of the articulated assembly (B), designated as costal (B1), and which also ascend the lower part of the articulated assembly (B), designated as leg support (B3) clockwise, (from 180° to 270°) and vice versa. In order to allow these oscillations, the parts (B1 and B3) of the articulated assembly (B) are fixed to the seat (B2) of the same set by means of hinges and cardans (J).

On the other hand, the articulated device with lifting mechanism (A) for the transfer of bedridden patients or with reduced mobility, besides assuming a stretcher or chair configuration, according to the necessity of its user, it still enables the transfer of him to another surface (bed, chair, etc.) through lateral displacement (F and G) and transfer (E, L and H) mechanisms.

Lateral displacement mechanism (F and G), according to FIG. 2, which is placed and fixed between the costal, seat and leg support parts, B1, B2 and B3, respectively, and the articulated support (B4) composed of a set of six slides (F), which enable the articulated support (B) to slide outward or inward from the center of the articulated support (B4) in the right lateral direction, by means of the actuator (G) installed in the inner part of the left side of the articulated support (B4) and in the lower part of the seat (B2), allowing said set (B1, B2 and B3) to move closer to the pickup point if the user is lying down or if he wants to lay down in bed or if, in another instance for example, the user wants to sit or if he is seating in a vehicle.

In turn, the transfer mechanism (E, L and H), according to FIG. 3, allows, by means of a three rolling belts set (E) in vinylic canvas, integrated in B1, B2 and B3 and actuated by the rotor (H), installed at the upper left of the costal (B1), which is connected to the rolls (L), to pick up or deliver back the user outward or inward of the articulated assembly (B), this being able, independently or synchronously, to assume several positions, by means of two actuators (I).

### ADVANTAGES

The present invention substitutes the crane, stretcher and wheelchair among others, because in a secure, comfortable and smooth way, the articulated device can remove from the bed in the laying down position (FIG. 6) someone that, independently of weight, is impaired or with reduced mobility. Due to this, the device enables a great economy of human resources and materials with a greater advantage for who needs this type of equipment, either from the points of view of the caretaker or the patient/user, due to the dignity it allows, and also having the ability to displace the patient/user for the several tasks that have to be executed by or with the patient/user inside a hospital unit or inside a house or institution.

### DESCRIPTION OF THE DRAWINGS

FIG. 1—Drawing in a left lateral/frontal perspective of the articulated device composed of an articulated set (B), which sits in the upper part of the lifting mechanism (A), which in turn is supported by the carrying body (C).

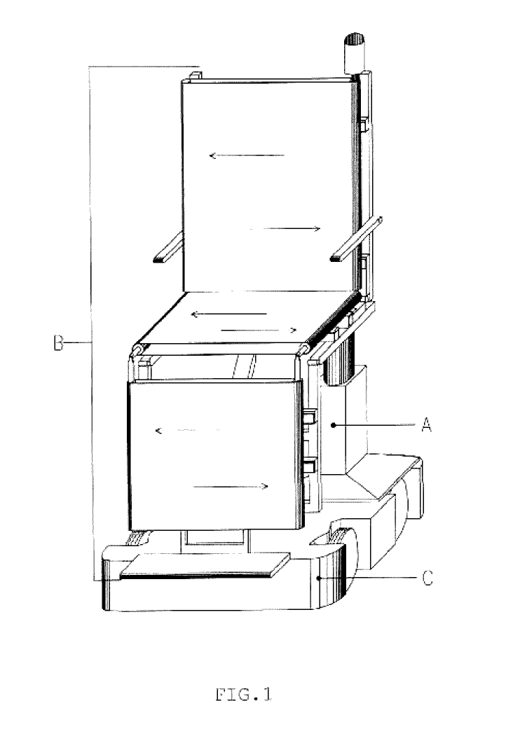

FIG. 2—Left lateral/frontal perspective view of the lateral displacement mechanism, in which we can visualize the articulated assembly (B) composed of the costal (B1), seat (B2), leg support (B3), interconnected by a hinges and cardans system, (J) and fixed to the articulated support (B4), by means of a set of six slides (F), which allow the articulated assembly (B) to slide outward or inward from the center of the articulated support (B4) in the right lateral direction by means of actuator (G) installed in the lower part of the left side of the articulated support (B4) and in the lower part of the seat (B2); each of the parts B1, B2 and B3 integrate a rolling belt in vinylic canvas (E), these being rotated to the right or left by the rotor (H), installed at the upper left part of (B1), which is connected to rolls (L) and which function is to displace or pick up the person outward or inward of the articulated assembly (B), the latter being able to, independently or synchronously, by means of two actuators (I), assume several positions, from the chair shape to the stretcher shape.

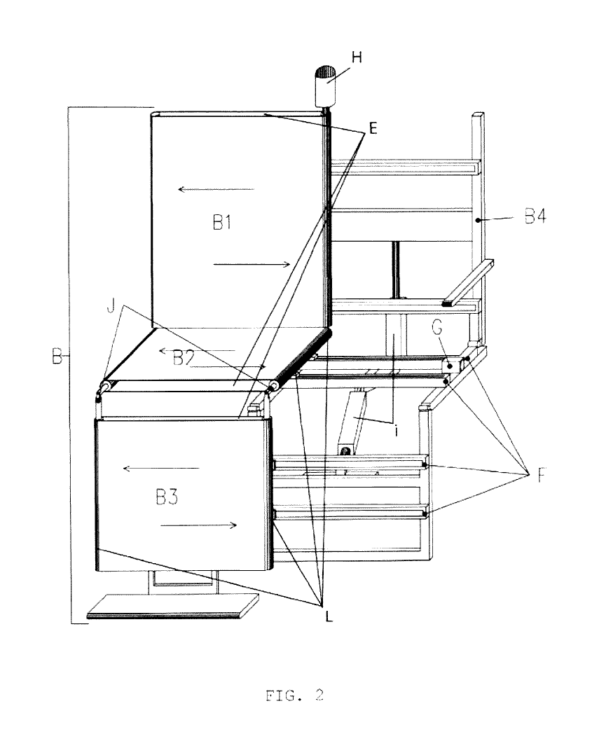

FIG. 3—Left lateral/frontal perspective view of the transfer mechanism which enables, by means of a three rolling belts set (E), to pick up or deliver back the user from or to the bed or other equipment, the rolling belts (E) being rotated to the right or left by action of the rotor (H) installed at the upper left part of (B1), which is connected to the rolls (L).

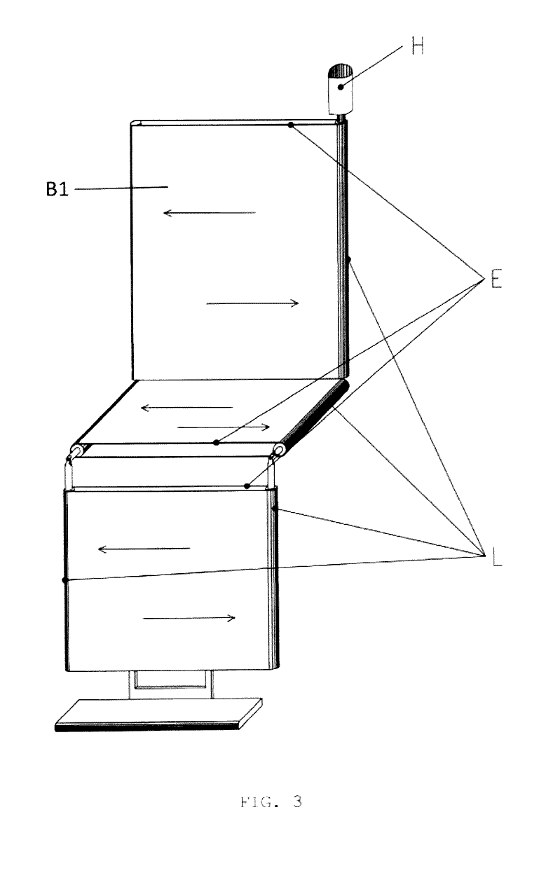

FIG. 4—Left lateral/frontal perspective view of the articulated support (B4), based on the telescopic actuator (A) supported by the carrying body (C) and provided with actuators (I) which allow the oscillation that enables B4 to assume several positions.

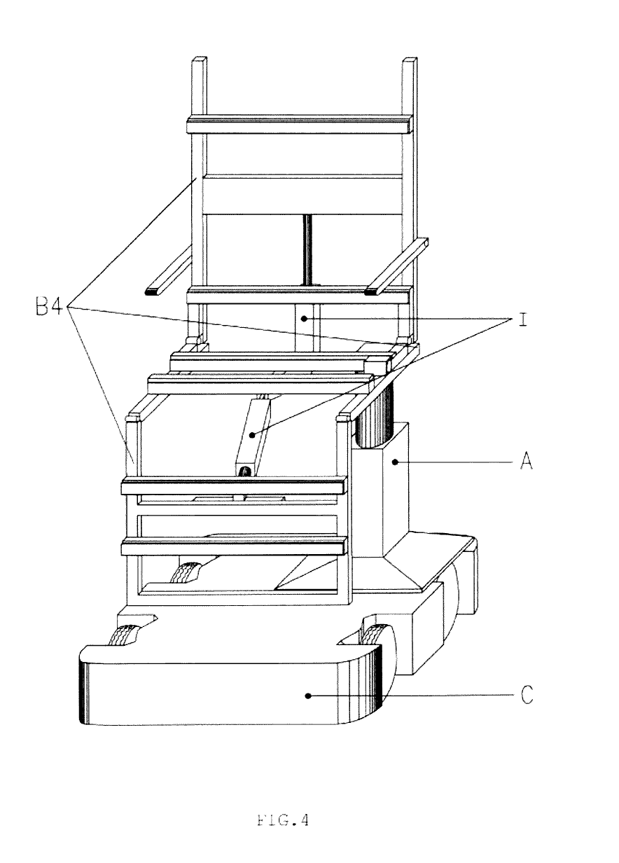

FIG. 5—Lateral profile view of the articulated device in the chair position, by means of the actuators (I), based on the lifting mechanism (A), which in turn is supported by the carrying body (C) and which movement depends on the wheels (D).

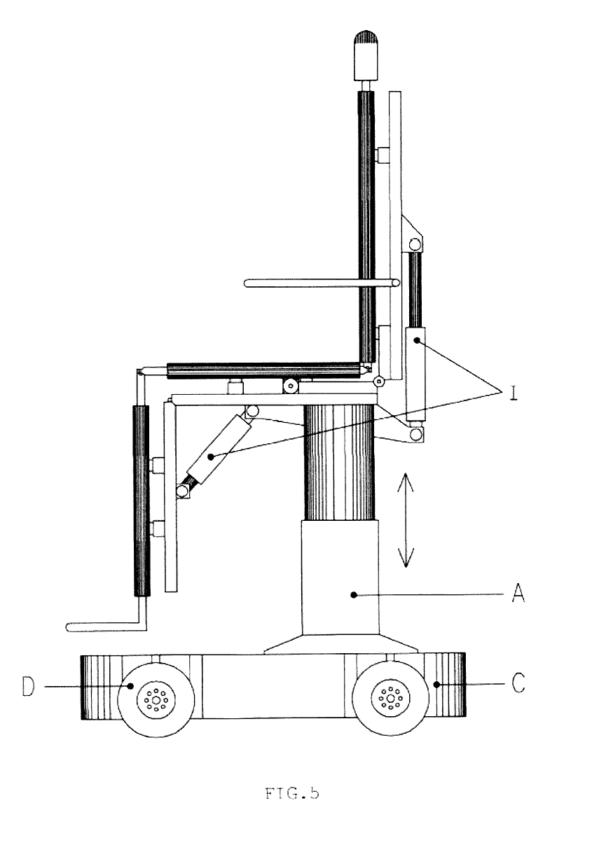

FIG. 6—Lateral profile view of the articulated device (B) in the stretcher position, by means of the actuator (G).

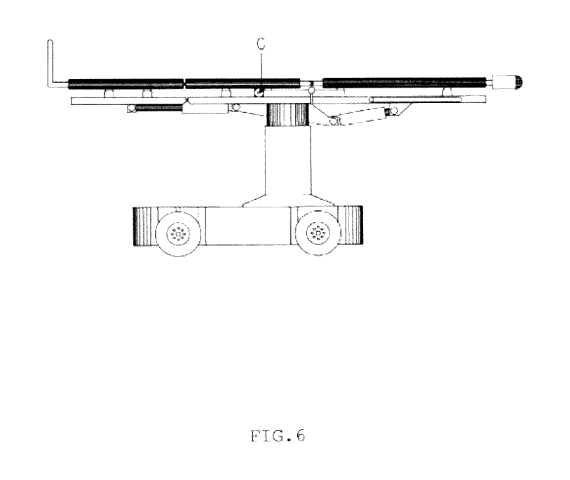

FIG. 7—Left frontal/lateral perspective view of the articulated assembly (B1, B2, B3) in the chair position and fixed by means of hinges and cardans (J) and composed of a six slides set (F) which enable it to slide outward or inward from the center of the articulated support (B4).

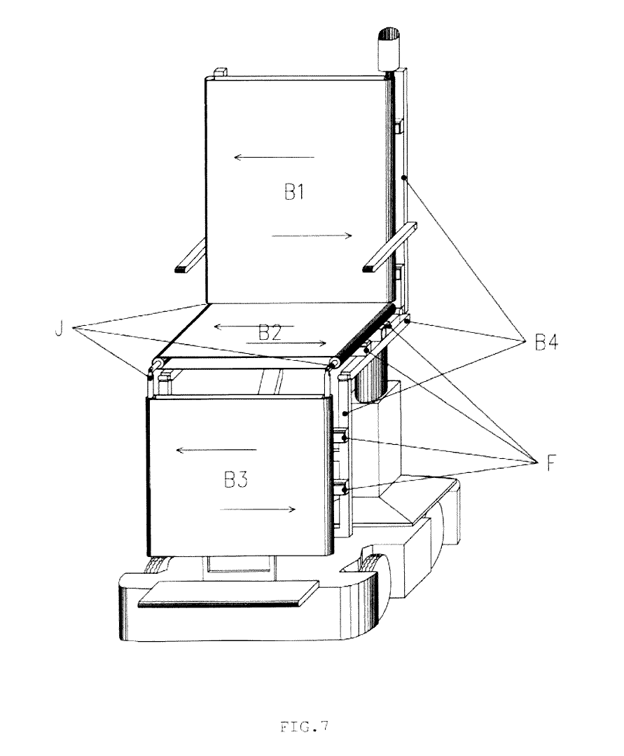

FIG. 8—Left frontal/lateral perspective view which identifies the transfer mechanism and its elements, the belts (E), the Cardans (J), the rolls (L) and the Rotor (H).

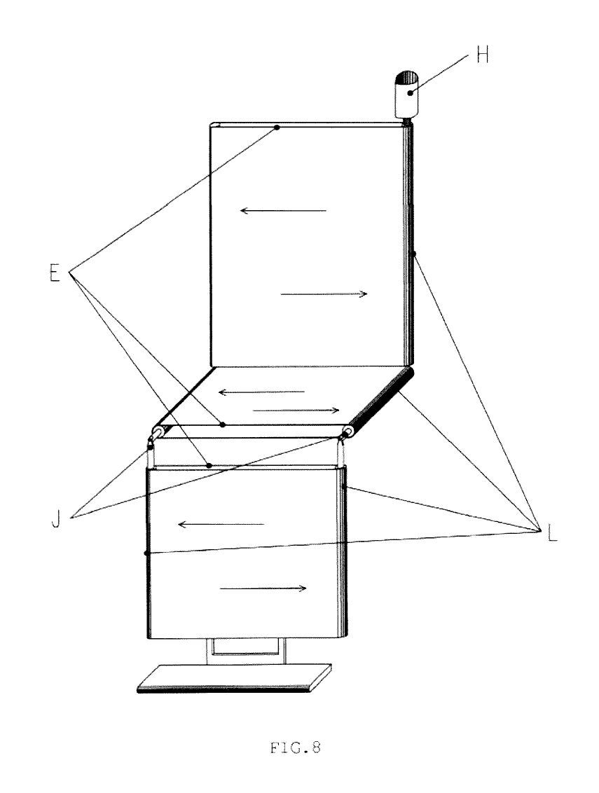

FIG. 9—Front view of the articulated device in the stretcher position, displaced outward from its axis.

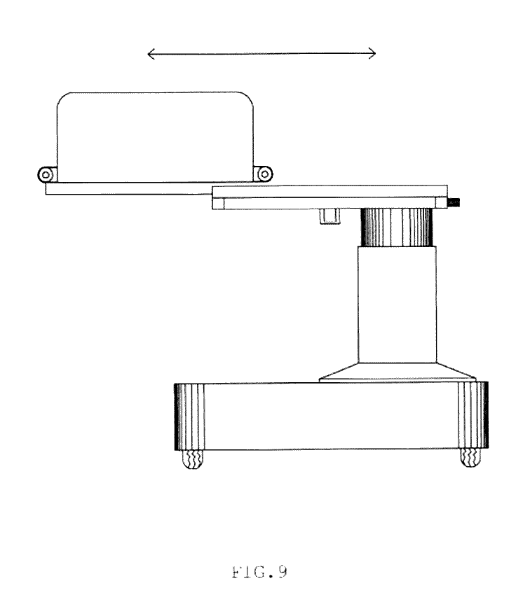

FIG. 10—Front view of the articulated device in the stretcher position, displaced outward from its axis.

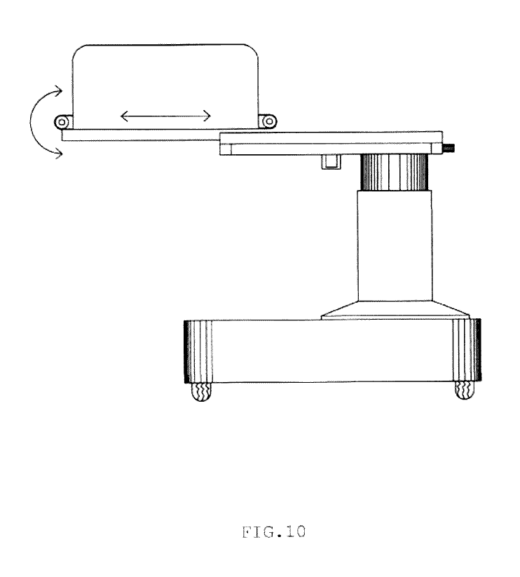

1. Articulated device for the transfer of bedridden patients or with reduced mobility, comprising:
a lifting mechanism and supported by a carrying body, characterized by being composed of an articulated set, a lateral displacement mechanism and a transfer mechanism.

2. The Articulated device for the transfer of bedridden patients or with reduced mobility, according to claim 1, wherein the articulated set is composed of three elements, the costal, the seat and the leg support, interconnected by hinge and cardans mechanisms and fixed to the articulated support by means of slides.

3. The Articulated device for the transfer of bedridden patients or with reduced mobility, according to claim 1, wherein the costal, the seat and the leg support elements each having a belt made of canvas installed around both rolls, which are connected to one another by means of cardans, being actuated by a rotor.

4. The Articulated device for the transfer of bedridden patients or with reduced mobility, according to claim 1, further comprising a transfer mechanism, comprised by a set of three rolling belts actuated by a rotor installed at the upper left of, which is connected to the rolls, given that the movement of the rolling belts allows picking up or delivering back the user.

5. The Articulated device for the transfer of bedridden patients or with reduced mobility, according to claim 1, wherein comprising:
a mechanism of lateral displacement, composed of a set of six slides, which allow to slide outward or inward from the center of the articulated support in the right lateral direction, by means of the actuator installed in the inner part of the left side of the articulated support and in the lower part of the seat.

6. The Articulated device for the transfer of bedridden patients or with reduced mobility, according to claim 1, wherein the articulated device is able to assume several positions, including horizontal (lying) or vertical (sitting).
